(19) United States
(12) Patent Application Publication
(10) Pub. No.: US 2023/0328807 A1
(43) Pub. Date: Oct. 12, 2023

(54) METHODS AND APPARATUSES FOR DESIGNING AN ADAPTATION LAYER AND HANDLING A FAILURE IN A SIDELINK RELAY SYSTEM

(71) Applicant: LENOVO (BEIJING) LIMITED, BEIJING (CN)

(72) Inventors: LIANHAI WU, BEIJING (CN); MINGZENG DAI, SHANGHAI (CN); HAIMING WANG, BEIJING (CN); JIE SHI, BEIJING (CN); JIE HU, BEIJING (CN)

(21) Appl. No.: 18/040,826

(22) PCT Filed: Aug. 7, 2020
(86) PCT No.: PCT/CN2020/107710

§ 371 Date: Feb. 7, 2023

(51) Int. Cl. H04W 76/10; H04W 76/20; H04L 1/1812; H04L 1/08

(52) U.S. Cl. CPC H04W 76/10; H04L 1/08; H04L 1/1812; H04W 76/20; H04W 92/18

(57) ABSTRACT

Embodiments of the present application relate to methods and apparatuses for designing an adaptation layer and handling a failure in a sidelink relay system under 3rd Generation Partnership Project (3GPP) 5G New Radio (NR). According to an embodiment of the present application, a method can include: receiving a radio resource control (RRC) setup request from a user equipment (UE), wherein a PC5 RRC connection of a link between the UE and a relay UE has been established; transmitting a RRC setup request to a base station (BS), wherein a RRC connection of a link between the relay UE and the BS has been established; receiving response information from the BS, wherein the response information includes at least one of a cell radio network temporary identifier (C-RNTI) and an identifier (ID) of the UE; and transmitting the response information to the UE. A failure could happen after a relayed connection of a link between the UE and the BS being established. The relay UE needs to transmit a notification to the UE when a radio link failure (RLF) between the relay UE and the BS happens. Furthermore, the relay UE needs to transmit a notification to the BS when a RLF between the relay UE and the UE happens.

### TECHNICAL FIELD

Embodiments of the present application generally relate to wireless communication technology, especially to methods and apparatuses for designing an adaptation layer and handling a failure in a sidelink relay system.

### BACKGROUND

Vehicle to everything (V2X) has been introduced into 5G wireless communication technology. In terms of a channel structure of V2X communication, the direct link between two user equipments (UEs) is called a sidelink. A sidelink is a long-term evolution (LTE) feature introduced in 3GPP Release 12, and enables a direct communication between proximal UEs, and data does not need to go through a base station (BS) or a core network.

In the 3rd Generation Partnership Project (3GPP), deployment of a relay node (RN) in a wireless communication system is promoted. One objective of deploying a RN is to enhance the coverage area of a BS by improving the throughput of a user equipment (UE) that is located in the coverage or far from the BS, which can result in relatively low signal quality. A RN may also be named as a relay UE in some cases. A 3GPP 5G sidelink system including a relay UE may be named as a sidelink relay system.

Currently, in a 3GPP 5G New Radio (NR) system or the like, details regarding how to design an adaptation layer and handle a failure in a sidelink relay system has not been specifically discussed yet.

### SUMMARY

Some embodiments of the present application provide a method for wireless communications. The method may be performed by a relay UE. The method includes: receiving a radio resource control (RRC) setup request from a UE, wherein a PC5 RRC connection of a link between the UE and the relay UE has been established; transmitting a RRC setup request to a BS, wherein a RRC connection of a link between the relay UE and the BS has been established; receiving response information from the BS, wherein the response information includes at least one of a cell radio network temporary identifier (C-RNTI) and an identifier (ID) of the UE; and transmitting the response information to the UE.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the above-mentioned method for receiving response information performed by a relay UE.

Some embodiments of the present application provide a further method for wireless communications. The method may be performed by a BS. The method includes: receiving a RRC setup request from a relay UE, wherein a PC5 RRC connection of a link between a UE and the relay UE has been established, and wherein a RRC connection of a link between the relay UE and the BS has been established; and transmitting response information to the relay UE, wherein the response information includes at least one of a C-RNTI and an ID of the UE.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the above-mentioned method for transmitting response information performed by a BS.

Some embodiments of the present application provide a further method for wireless communications. The method may be performed by a relay UE. The method includes: establishing a PC5 RRC connection of a link between a UE and the relay UE; establishing a RRC connection of a link between the relay UE and a BS; establishing a relayed connection of a link between the UE and the BS; detecting whether a failure occurs on the link between the UE and the relay UE; and in response to detecting that the failure occurs on the link between the relay UE and the UE, transmitting failure information to the BS.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the above-mentioned method for transmitting failure information performed by a relay UE.

Some embodiments of the present application provide a further method for wireless communications. The method may be performed by a relay UE. The method includes: establishing a relayed logical connection of a link between a UE and a BS; detecting whether a failure occurs on a link between the relay UE and the BS, wherein a PC5 RRC connection of a link between the UE and the relay UE has been established, and wherein an RRC connection of a link between the relay UE and the BS has been established; and in response to detecting that the failure occurs on the link between the relay UE and the BS, transmitting a failure notification to the UE.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the above-mentioned method for transmitting a failure notification performed by a relay UE.

Some embodiments of the present application provide a further method for wireless communications. The method may be performed by a UE. The method includes: receiving a notification associated with a failure from a relay UE, wherein a PC5 RRC connection of a link between the UE and the relay UE has been established, wherein a RRC connection of a link between the relay UE and a BS has been established, and wherein the notification associated with a failure indicates a failure on a link between the relay UE and the BS; and initiating a relay reselection procedure.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the above-mentioned method for initiating a relay reselection procedure performed by a UE.

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application;

FIG. 2 illustrates an exemplary flowchart of a sidelink RRC reconfiguration procedure in accordance with some embodiments of the present application;

FIG. 3 illustrates an exemplary flowchart of a sidelink UE information procedure in accordance with some embodiments of the present application;

FIG. 4 illustrates exemplary protocol stacks with a sidelink adaptation protocol (SLAP) layer in accordance with some embodiments of the present application;

FIG. 5 illustrates a flow chart of a method for receiving response information in accordance with some embodiments of the present application;

FIG. 6 illustrates a flow chart of a method for transmitting response information in accordance with some embodiments of the present application;

FIG. 7 illustrates a flow chart of a method for transmitting failure information in accordance with some embodiments of the present application;

FIG. 8 illustrates a flow chart of a method for transmitting a failure notification in accordance with some embodiments of the present application;

FIG. 9 illustrates a flow chart of a method for initiating a relay reselection procedure in accordance with some embodiments of the present application; and

FIG. 10 illustrates a simplified block diagram of an apparatus for a failure handling procedure in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

FIG. 1 illustrates a schematic diagram of a wireless communication system in accordance with some embodiments of the present application.

As shown in FIG. 1, the wireless communication system 100 includes a UE 101, a BS 102, and a relay UE 103 for illustrative purpose. Although a specific number of UE(s), relay UE(s), and BS(s) are depicted in FIG. 1, it is contemplated that any number of UE(s), relay UE(s), and BS(s) may be included in the wireless communication system 100.

Due to a far distance between the UE 101 and the BS 102, these they communicate with each other via the relay UE 103. The UE 101 may be connected to the relay UE 103 via a network interface, for example, a PC5 interface as specified in 3GPP standard documents. The relay UE 103 may be connected to the BS 102 via a network interface, for example, a Uu interface as specified in 3GPP standard documents. Referring to FIG. 1, the UE 101 is connected to the relay UE 103 via a PC5 link, and the relay UE 103 is connected to the BS 102 via a Uu link.

In some embodiments of the present application, the UE 101 or the relay UE 103 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

In some further embodiments of the present application, the UE 101 or the relay UE 103 may include a portable wireless communication device, a smart phone, a cellular telephone, a flip phone, a device having a subscriber identity module, a personal computer, a selective call receiving circuitry, or any other device that is capable of sending and receiving communication signals on a wireless network.

In some other embodiments of the present application, the UE 101 or the relay UE 103 may include wearable devices, such as smart watches, fitness bands, optical head-mounted displays, or the like. Moreover, the UE 101 or the relay UE 103 may be referred to as a subscriber unit, a mobile, a mobile station, a user, a terminal, a mobile terminal, a wireless terminal, a fixed terminal, a subscriber station, a user terminal, or a device, or described using other terminology used in the art.

BS(s) 102 may be distributed over a geographic region. In certain embodiments of the present application, each of the BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G NR of the 3GPP protocol, wherein BS(s) 102 transmit data using an OFDM modulation scheme on the downlink (DL), and UE(s) 101 (e.g., the UE 101 or other similar UE) transmit data on the uplink (UL) using a Discrete Fourier Transform-Spread-Orthogonal Frequency Division Multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present application, BS(s) 102 may communicate using other communication protocols, such as the IEEE 802.11 family of wireless communication protocols. Further, in some embodiments of the present application, BS(s) 102 may communicate over licensed spectrums, whereas in other embodiments, BS(s) 102 may communicate over unlicensed spectrums. The present application is not intended to be limited to the implementation of any particular wireless communication system architecture or protocol. In yet some embodiments of present application, BS(s) 102 may communicate with UE(s) 101 using the 3GPP 5G protocols.

UE(s) 101 may access BS(s) 102 to receive data packets from BS(s) 102 via a downlink channel and/or transmit data packets to BS(s) 102 via an uplink channel. In normal operation, since UE(s) 101 does not know when BS(s) 102 will transmit data packets to it, UE(s) 101 has to be awake all the time to monitor the downlink channel (e.g., a Physical Downlink Control Channel (PDCCH)) to get ready for receiving data packets from BS(s) 102. However, if UE(s) 101 keeps monitoring the downlink channel all the time even when there is no traffic between BS(s) 102 and UE(s) 101, it would result in significant power waste, which is problematic to a power limited UE or a power sensitive UE.

FIG. 2 illustrates an exemplary flowchart of a sidelink RRC reconfiguration procedure in accordance with some embodiments of the present application.

As shown in FIG. 2, in step 201, UE (a) (e.g., the UE 101 as illustrated and shown in FIG. 1) initiates a sidelink RRC reconfiguration procedure to UE (b) (e.g., the relay UE 103 as illustrated and shown in FIG. 1) by transmitting a RRCReconfigurationSidelink message to UE (b).

If the sidelink RRC reconfiguration procedure is successfully completed, in step 202, UE (b) may transmit “a RRC reconfiguration complete sidelink message” to UE (a), e.g., a RRCReconfigurationCompleteSidelink message as specified in 3GPP standard documents. Alternatively, if the sidelink RRC reconfiguration procedure is not successfully completed, in step 202, UE (b) may transmit “a RRC reconfiguration failure sidelink message” to UE (a), e.g., a RRCReconfigurationFailureSidelink message as specified in 3GPP standard documents.

The purpose of a sidelink RRC reconfiguration procedure is to modify a PC5 RRC connection, e.g., to establish, modify, or release sidelink data radio bearers (DRBs), to configure NR sidelink measurement and reporting, and to configure sidelink channel state information (CSI) reference signal resources.

A UE (e.g., UE (a) as illustrated and shown in FIG. 2) may initiate the sidelink RRC reconfiguration procedure and perform operations on the corresponding PC5 RRC connection in following cases:
a release of sidelink DRBs associated with a peer UE (e.g., UE (b) as illustrated and shown in FIG. 2);
an establishment of sidelink DRBs associated with the peer UE;
a modification for the parameters included in Sidelink radio bearer (SLRB)-Config of sidelink DRBs associated with the peer UE;
configuration information of the peer UE to perform NR sidelink measurement and report; and
configuration information of the sidelink CSI reference signal resources.

A UE capable of NR sidelink communication may initiate a procedure of sidelink UE information for NR, to report to a network or a BS that a sidelink radio link failure (RLF) (e.g., timer T400 expiry) or a sidelink RRC reconfiguration failure has been declared.

The following table shows an introduction of timer T400 as specified in 3GPP standard documents, including a starting condition, a stop condition, an operation at expiry, and a possible general name for the timer.

| | | | | |
|---|---|---|---|---|
| Timer | Start | Stop | At expiry | Name |
| T400 | upon transmissio n of RRCReconf igurationSid elink | upon reception of RRCReconfiguration FailureSidelink or RRCReconfiguration CompleteSidelink | perform the sidelink RRC reconfiguration failure procedure as specified in sub-clause 5.8.9.1.8 of TS38.331 | a timer for transmissio n of RRC reconfigurat ion for sidelink |

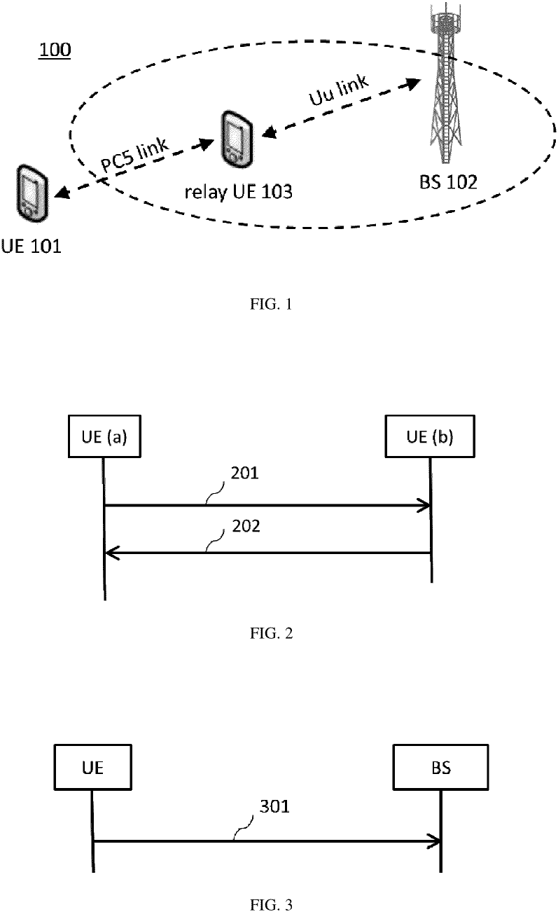

FIG. 3 illustrates an exemplary flowchart of a sidelink UE information procedure in accordance with some embodiments of the present application.

As shown in FIG. 3, in step 301, a UE (e.g., the UE 101 as illustrated and shown in FIG. 1 or UE (a) as illustrated and shown in FIG. 2) transmits “a sidelink UE information NR message” to a BS (e.g., the BS 102 as illustrated and shown in FIG. 1), e.g., a SidelinkUEinformationNR message as specified in 3GPP standard documents. Specifically, the sidelinkUEinformationNR message may include sidelink failure information. The sidelink failure information may include a sidelink destination ID and a sidelink failure cause.

Currently, in a sidelink relay system under 3GPP 5G NR, details regarding how to design an adaptation layer and handle a failure has not been specifically discussed yet. Embodiments of the present application provide a failure handling procedure in a sidelink relay system, for example, whether a relay UE reports a failure notification to a UE when a RLF of the link between the relay UE and another UE happens or when the relay UE receives a RRCReconfigurationFailureSidelink message from another UE. More details will be illustrated in the following text in combination with the appended drawings.

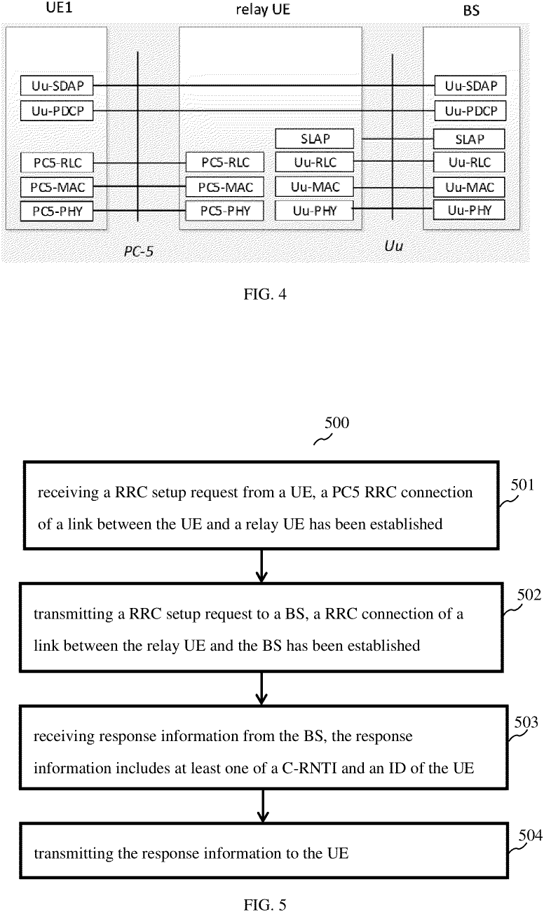

FIG. 4 illustrates exemplary protocol stacks with a sidelink adaptation protocol (SLAP) layer in accordance with some embodiments of the present application.

The embodiments of FIG. 4 show protocol stacks at each side of UE1 (e.g., the UE 101 as illustrated and shown in FIG. 1, UE (a) as illustrated and shown in FIG. 2, or the UE as illustrated and shown in FIG. 3), a relay UE (e.g., the relay UE 103 as illustrated and shown in FIG. 1 or UE (b) as illustrated and shown in FIG. 2), and a BS (e.g., the BS 102 as illustrated and shown in FIG. 1, or the BS as illustrated and shown in FIG. 3). The UE1 is connected to the relay UE via a PC-5 interface, which may also be named as a PC5 interface. The relay UE is connected to the BS via a Uu interface.

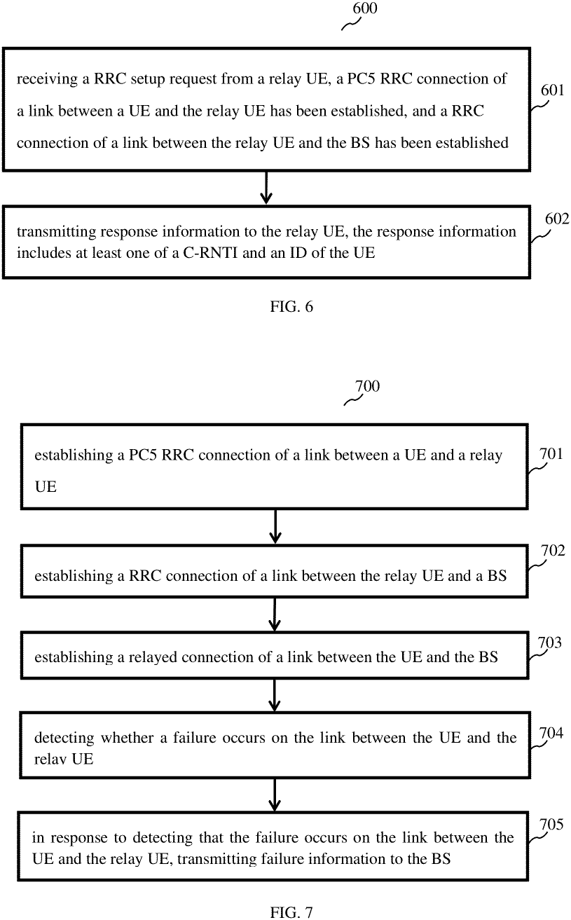

In particular, as shown in FIG. 4, the UE1 side includes protocol layers of PC5-PHY, PC5-MAC, PC5-RLC, Uu-PDCP, and Uu-SDAP. The relay UE side includes protocol layers of PC5-PHY, PC5-MAC, PC5-RLC, Uu-PHY, Uu-MAC, and Uu-RLC. The BS side inclues protocol layers of Uu-PHY, Uu-MAC, Uu-RLC, Uu-PDCP, and Uu-SDAP. According to some embodiments of the present application, the relay UE side and the BS side further include a SLAP layer, as shown in FIG. 4. Specific examples of using the SLAP layer are described in the following embodiments, e.g., FIGS. 5 and 6.

FIG. 5 illustrates a flow chart of a method for receiving response information in accordance with some embodiments of the present application. The method may be performed by a relay UE (e.g., the relay UE 103 illustrated and shown in FIG. 1 or UE (b) as illustrated and shown in FIG. 2). Although described with respect to a UE, it should be understood that other devices may be configured to perform a method similar to that of FIG. 5.

In the exemplary method 500 as shown in FIG. 5, in operation 501, a relay UE receives a RRC setup request from a UE (e.g., the UE 101 illustrated and shown in FIG. 1). In operation 502, the relay UE transmits a RRC setup request to a BS (e.g., the BS 102 as illustrated and shown in FIG. 1, or the BS as illustrated and shown in FIG. 3). The embodiments of FIG. 5 assume that a PC5 RRC connection of a link between the UE and the relay UE has been established and a RRC connection of a link between the relay UE and the BS has been established.

In operation 503, the relay UE receives response information from the BS. The response information includes at least one of a C-RNTI and an ID of the UE. In an example, at least one of the C-RNTI and the ID of the UE is used in a header of a SLAP layer of the relay UE.

In operation 504, the relay UE transmits the response information to the UE. In an example, the response information includes a mapping association between the C-RNTI and the ID of the UE. The response information may further include configuration information of the SLAP layer of the relay UE. In a further example, the response information includes an ID of a logical channel between the UE and the BS. Specifically, the relay UE or the BS may configure a UE ID with a reduced size to be included in a header of a packet data unit (PDU) format. Therefore, the mapping between a C-RNTI and an UE ID with reduced size should be configured.

In another example, the response information includes a mapping association between “an ID of a logical channel between the UE and the relay UE” and “an ID of a logical channel between the relay UE and the BS”. In other words, in this example, an ID of a logical channel between the first UE and the relay UE is included in the header of the PDU format. After the relay UE receives a packet from the UE in one logical channel ID, the relay UE will deliver this PDU including this packet to the corresponding ID of logical channel between the relay UE and the BS based on the mapping association.

In an additional example, the response information includes a mapping association between “the ID of the logical channel between the UE and the relay UE” and “an ID of a logical channel between the UE and the BS”. In other words, in this example, an ID of a logical channel between the first UE and the BS is included in the header of the PDU format. After the relay UE receives the packet from the UE in one logical channel ID, the relay UE will add this ID of logical channel between the UE and the BS based on the mapping association in the header of the PDU format and deliver this PDU including this packet to one logical channel between the relay UE and the BS based on the mapping association.

In an embodiment, the relay UE further receives a RRC setup complete message from the UE, and transmits the RRC setup complete message to the BS.

In a further embodiment, the relay UE receives, from the UE, one or more packets associated with different UE bearers. Then, the relay UE transmits, to the BS, a SLAP PDU, which includes the received one or more packets. A header of the SLAP PDU may include one or more logical channel IDs related to the one or more packets. The one or more logical channel IDs may be “an ID of a logical channel between the UE and the relay UE” or “an ID of a logical channel between the UE and the BS”. That is to say, multiple packets associated with different UE bearers can be multiplexed to one PDU format. Multiple logical channel ID should be added in the header.

Details described in all other embodiments of the present application (for example, details regarding response information received from a BS) are applicable for the embodiments of FIG. 5. Moreover, details described in the embodiments of FIG. 5 are applicable for all the embodiments of FIGS. 1-4 and 6-10.

FIG. 6 illustrates a flow chart of a method for transmitting response information in accordance with some embodiments of the present application. The method may be performed by a BS (e.g., the BS 102 as illustrated and shown in FIG. 1, or the BS as illustrated and shown in FIG. 3). Although described with respect to a BS, it should be understood that other devices may be configured to perform a method similar to that of FIG. 6.

In the exemplary method 600 as shown in FIG. 6, in operation 601, a BS receives a RRC setup request from a relay UE (e.g., the relay UE 103 illustrated and shown in FIG. 1 or UE (b) as illustrated and shown in FIG. 2). The embodiments of FIG. 6 assume that a PC5 RRC connection of a link between a UE (e.g., the UE 101 illustrated and shown in FIG. 1) and the relay UE has been established, and wherein a RRC connection of a link between the relay UE and the BS has been established. In operation 602, the BS transmits response information to the relay UE. The response information includes at least one of a C-RNTI and an ID of the UE.

The response information in the embodiments of FIG. 6 is of similar formats or contents to those of the response information in the embodiments of FIG. 5. For instance, similar to the embodiments of FIG. 5, in the embodiments of FIG. 6, the response information may include a mapping association between the C-RNTI and the ID of the UE. The response information may further include an ID of a logical channel between the UE and the BS.

In an example, the BS receives a RRC setup complete message from the relay UE. For instance, the UE transmits the RRC setup complete message to the relay UE, and then the relay UE transmits the RRC setup complete message to the BS.

In a further example, the BS receives a SLAP PDU from the relay UE. The SLAP PUD includes one or more packets associated with different UE bearers. The one or more packets are transmitted from the UE. A SLAP PDU in the embodiments of FIG. 6 may be of similar formats or contents to those of SLAP PDU in the embodiments of FIG. 5.

Details described in all other embodiments of the present application (for example, details regarding response information transmitted to a relay UE) are applicable for the embodiments of FIG. 6. Moreover, details described in the embodiments of FIG. 6 are applicable for all the embodiments of FIGS. 1-5 and 7-10.

The following texts describe specific Embodiment 1 of the methods as shown and illustrated in FIGS. 5 and 6.

### Embodiment 1

According to Embodiment 1, a UE (e.g., the UE 101 as shown and illustrated in FIG. 1), a relay UE (e.g., the relay UE 103 illustrated and shown in FIG. 1), and a BS (e.g., the BS 102 as illustrated and shown in FIG. 1) perform the following steps:
(1) A RRC connection of a PC5 link between the UE 101 and the relay UE 103 has been already established. A RRC connection of a Uu link between the relay UE and the BS 102 has been already established.
(2) The UE 101 transmits a RRC setup request to the relay UE 103.
(3) The relay UE 103 transfers the RRC setup request to the BS 102.
   The RRC setup request can be contained in another RRC message, e.g., a RRCReconfigurationSidelink message. That is to say, the relay UE 103 may transmit the RRCReconfigurationSidelink message, which includes the RRC setup request, to the BS 102.
(4) The BS 102 transmits a RRC reconfiguration message including a response to the relay UE 103. The response is relayed by the relay UE 103 and transmitted to the UE 101.
   The RRC reconfiguration message relayed by the relay UE 103 may include a C-RNTI of the UE 101. The RRC reconfiguration message may further include a mapping association between the C-RNTI and an ID of the UE 101. At least one of the C-RNTI and an ID of the UE 101 is to be included in a header of a SLAP layer of the relay UE 103.
(5) The relay UE 103 transfers the response to the UE 101.
   After receiving the RRC setup request, the BS 102 may transmit a RRC setup message to the UE 101 via the relay UE 103. The RRC setup message may be included in the response transferred by the relay UE 103.
(6) The UE 101 transmits a RRC setup complete message to the BS 102 via the relay UE 103.
   An ID of the he UE 101, e.g., C-RNTI should be added in the RRC setup complete message.
(7) The UE 101 will transmit data packets associated with different logical channel IDs to the relay UE 103.
(8) After the relay UE 103 receives multiple data packets associated with different logical channel IDs, the relay UE 103 may transmit a PDU format to the BS 102.
   The multiple data packets associated with different UE bearers can be multiplexed to one PDU format.
   Multiple logical channel IDs should be added in a header of the PDU format.
(9) The BS 102 receives the PDU format including the multiple data packets that are associated with the different UE bearers.
   The BS 102 can differentiate the different UE bearers based on the logical channel IDs in the header of the PDU format.

FIG. 7 illustrates a flow chart of a method for transmitting failure information in accordance with some embodiments of the present application. The method may be performed by a relay UE (e.g., the relay UE 103 illustrated and shown in FIG. 1 or UE (b) as illustrated and shown in FIG. 2). Although described with respect to a UE, it should be understood that other devices may be configured to perform a method similar to that of FIG. 7.

In the exemplary method 700 as shown in FIG. 7, in operation 701, a relay UE (e.g., the relay UE 103 illustrated and shown in FIG. 1) establishes a PC5 RRC connection of a link between a UE (e.g., the UE 101 illustrated and shown in FIG. 1) and the relay UE.

In operation 702, the relay UE establishes a RRC connection of a link between the relay UE and a BS (e.g., the BS 102 as illustrated and shown in FIG. 1, or the BS as illustrated and shown in FIG. 3). In operation 703, the relay UE establishes a relayed connection of a link between the UE and the BS.

In operation 704, the relay UE detects whether a failure occurs on the link between the UE and the relay UE. In operation 705, if the relay UE detects that the failure occurs on the link between the UE and the relay UE, the relay UE transmits failure information to the BS. For instance, the failure information may be included in one of:
a sidelink UE information message, e.g., a SidelinkUEinformation message as specified in 3GPP standard documents;
a control PDU in a SLAP layer of the relay UE; and
a medium access control (MAC) control element (CE).

In some embodiments, the failure information includes an UE ID configured by the BS. The UE ID may be a C-RNTI or an ID of the UE. The UE ID can be used in a header of a SLAP layer of the relay UE.

In some other embodiments, the failure information includes at least one of: a failure cause; an ID of the UE; and an ID of the relay UE. The failure cause may be a listen before talk (LBT) failure or a beam failure recovery failure.

In some embodiments, based on at least one of the following conditions, the relay UE detects that the failure occurs on the link between the UE and the relay UE:
reaching a maximum number of retransmissions of a radio link control (RLC) entity of the relay UE;
an expiry of a timer for transmission of RRC reconfiguration for sidelink;
reaching a maximum number of consecutive hybrid automatic repeat request (HARQ) discontinuous transmission (DTX);
an integrity check failure;
a LBT failure; and
a beam failure recovery failure.

In some embodiments, the relay UE transmits a RRC reconfiguration sidelink message to the UE. In some cases, the relay UE further receives a RRC reconfiguration failure sidelink message from the UE. Upon receiving the RRC reconfiguration failure sidelink message, the relay UE detects that the failure occurs on the link between the UE and the relay UE.

Details described in all other embodiments of the present application (for example, details of how to handle a failure on a link between a UE and a relay UE) are applicable for the embodiments of FIG. 7. Moreover, details described in the embodiments of FIG. 7 are applicable for all the embodiments of FIGS. 1-6 and 8-10.

The following texts describe specific Embodiment 2 of the method as shown and illustrated in FIG. 7.

### Embodiment 2

According to Embodiment 2, a UE (e.g., the UE 101 as shown and illustrated in FIG. 1), a relay UE (e.g., the relay UE 103 illustrated and shown in FIG. 1), and a BS (e.g., the BS 102 as illustrated and shown in FIG. 1) perform the following steps:
(1) A RRC connection of a PC5 link between the UE 101 and the relay UE 103 has been already established. A RRC connection of a Uu link between the relay UE and the BS 102 has been already established.
(2) A relayed RRC connection of a link between the UE 101 and the BS 102 is established. The RRC relayed connection of the link is a logical link and may also be named as “an end-to-end link” between the UE 101 and the BS 102.
(3) There may be following possible steps of the relay UE 103:
   Step (3a): the relay UE 103 detects a sidelink RLF between the UE 101 and the relay UE 103 when at least one of the following conditions happens:
      upon an indication from a sidelink RLC entity of the relay UE 103 that the maximum number of retransmissions for a specific destination (i.e., the UE 101) has been reached; or
      upon an expiry of timer T400; or
      upon an indication from a sidelink MAC entity of the relay UE 103 that the maximum number of consecutive HARQ DTX for a specific destination has been reached; or
      upon an integrity check failure indication from a sidelink PDCP entity of the relay UE 103 concerning SL-SRB2 (sidelink signaling radio bearer 2) or SL-SRB3:
         a) a LBT failure; or
         b) a beam failure recovery failure.
   Step (3b): the relay UE 103 receives a RRCReconfigurationFailureSidelink message from the UE 101, after the relay UE 103 transmits a RRCReconfigurationSidelink message to the UE 101.
(4) The relay UE 103 reports failure information to the BS 102. The failure information may be different according to different cases 1-1 to 1-4 below.
   Case 1-1: a sidelink RLF between the UE 101 and the relay UE 103 happens. The relay UE will declare a sidelink RLF.
   Case 1-2: the relay UE 103 receives a RRCReconfigurationFailureSidelink message from the UE 101.
   For case 1-1 and case 1-2:
      The relay UE 103 reports failure information including an UE ID configured to the BS 102. The UE ID configured by the BS 102 could be a C-RNTI or an UE ID used in a SLAP layer of the relay UE 103.
      A SidelinkUEinformation message or a control PDU in a SLAP layer can be used to transmit the failure information.
   Case 1-3: the unlicensed spectrum is used to the PC5 link between the UE 101 and the relay UE 103. A LBT failure may need to be indicated to the BS 102.
   For case 1-3:
      a new cause (e.g., a LBT failure) should be added in a SidelinkUEinformation message; and
      the corresponding UE ID is also needed. For example, at least one of an ID of the UE 101 and an ID of the relay UE 103 is included in the SidelinkUEinformation message.
   Case 1-4: FR2 is used to the link between the UE 101 and the relay UE 103. A beam failure related information may be indicated to the BS 102.
   For case 1-4:
      In FR2, the BS 102 or the relay UE 103 will configure a set of available beam. Once all beams fail, the relay UE 103 reports a beam failure recovery failure and the corresponding UE ID (e.g., at least one of an ID of the UE 101 and an ID of the relay UE 103) to the serving cell of the BS 102.

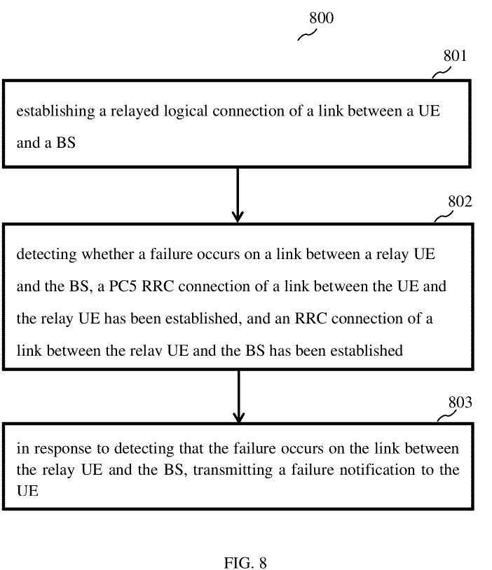

FIG. 8 illustrates a flow chart of a method for transmitting a failure notification in accordance with some embodiments of the present application. The method may be performed by a relay UE (e.g., the relay UE 103 illustrated and shown in FIG. 1 or UE (b) as illustrated and shown in FIG. 2). Although described with respect to a UE, it should be understood that other devices may be configured to perform a method similar to that of FIG. 8.

In the exemplary method 800 as shown in FIG. 8, in operation 801, a relay UE (e.g., the relay UE 103 illustrated and shown in FIG. 1) establishes a relayed logical connection of a link between a UE (e.g., the UE 101 illustrated and shown in FIG. 1) and a BS (e.g., the BS 102 as illustrated and shown in FIG. 1, or the BS as illustrated and shown in FIG. 3).

In operation 802, the relay UE detects whether a failure occurs on a link between the relay UE and the BS. The embodiments of FIG. 8 assume that a PC5 RRC connection of a link between the UE and the relay UE has been established, and a RRC connection of a link between the relay UE and the BS has been established.

In operation 803, if the relay UE detects that the failure occurs on the link between the relay UE and the BS, the relay UE transmits a failure notification to the UE. The failure occurs on the link between the relay UE and the BS may be a RLF. For instance, if the relay UE detects that a RLF occurs on the link between the relay UE and the BS, the failure notification is a RLF notification.

In an embodiment, if the relay UE completes a successful RRC re-establishment procedure, the relay UE transmits a successful recovery notification.

In a further embodiment, if the relay UE detects a RRC re-establishment failure on the link between the relay UE and the BS, the relay UE transmits a recovery failure notification.

In an example, the failure notification, the successful recovery notification, or the recovery failure notification may be included in one of:
a RRC signaling;
a control PDU in a SLAP layer; and
a MAC CE.

Details described in all other embodiments of the present application (for example, details of how to handle a failure on a link between a UE and a relay UE) are applicable for the embodiments of FIG. 8. Moreover, details described in the embodiments of FIG. 8 are applicable for all the embodiments of FIGS. 1-7, 9, and 10.

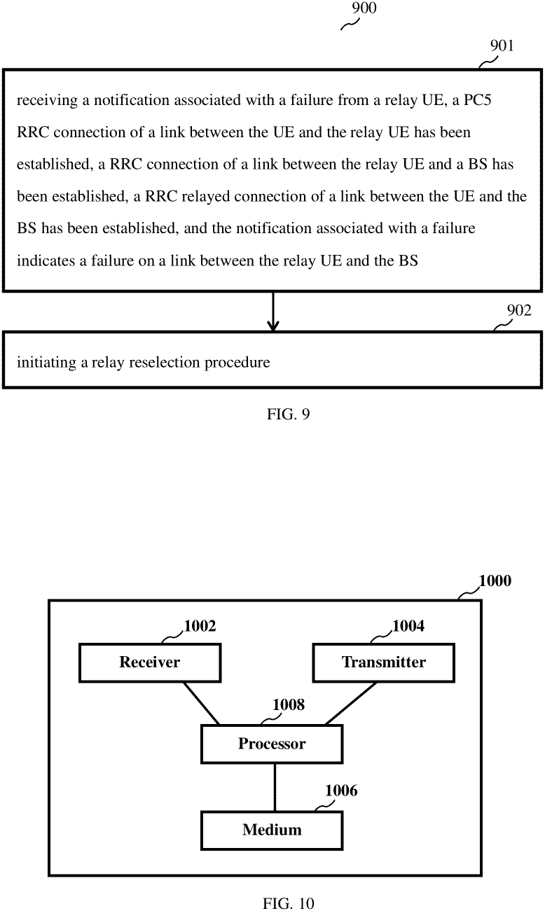

FIG. 9 illustrates a flow chart of a method for initiating a relay reselection procedure in accordance with some embodiments of the present application. The method may be performed by a UE (e.g., UE 101 as illustrated and shown in FIG. 1, UE (a) as illustrated and shown in FIG. 2, or the UE as illustrated and shown in FIG. 3). Although described with respect to a UE, it should be understood that other devices may be configured to perform a method similar to that of FIG. 9.

The embodiments of FIG. 9 assume that a PC5 RRC connection of a link between a UE (e.g., the UE 101 illustrated and shown in FIG. 1) and a relay UE (e.g., the relay UE 103 illustrated and shown in FIG. 1 or UE (b) as illustrated and shown in FIG. 2) has been established, a RRC connection of a link between the relay UE and a BS (e.g., the BS 102 as illustrated and shown in FIG. 1, or the BS as illustrated and shown in FIG. 3) has been established, and a RRC relayed connection of a link between the UE and the BS has been established.

In the exemplary method 900 as shown in FIG. 9, in operation 901, the UE receives a notification associated with a failure from the relay UE. The notification associated with a failure indicates a failure on a link between the relay UE and the BS. In an embodiment, an access stratum (AS) layer of the UE transmits the notification associated with a failure to a non-access stratum (NAS) layer of the UE.

In operation 902, the UE initiates a relay reselection procedure. The relay reselection procedure may be initiated in response to the notification associated with a failure indicating that a RLF of the link between relay UE and BS is detected. In an example, upon initiating the relay reselection procedure, the UE monitors a discovery resource pool.

In an embodiment, the UE receives a successful recovery notification from the relay UE. Upon receiving the successful recovery notification, the UE may stop the relay reselection procedure or stop monitoring a discovery resource pool.

In a further embodiment, the UE receives a recovery failure notification from the relay UE. The relay reselection procedure is initiated upon receiving the recovery failure notification from the relay UE. For instance, during initiating the relay reselection procedure, the UE monitors a discovery resource pool in response to receiving a recovery failure notification from the relay UE. Then, the UE may further selecting a second relay UE and establish a PC5 RRC connection of a link between the UE and the second relay UE.

In an example, each of the notification associated with a failure, the successful recovery notification, and the recovery failure notification may be included in a RRC signaling, a control PDU in a SLAP layer, or a MAC CE.

Details described in all other embodiments of the present application (for example, details of how to handle a failure on a link between a UE and a relay UE) are applicable for the embodiments of FIG. 9. Moreover, details described in the embodiments of FIG. 9 are applicable for all the embodiments of FIGS. 1-8 and 10.

The following texts describe specific Embodiment 3 of the methods as shown and illustrated in FIGS. 8 and 9.

### Embodiment 3

According to Embodiment 3, a UE (e.g., the UE 101 as shown and illustrated in FIG. 1), a relay UE (e.g., the relay UE 103 illustrated and shown in FIG. 1), and a BS (e.g., the BS 102 as illustrated and shown in FIG. 1) perform the following steps:
(1) A RRC connection of a PC5 link between the UE 101 and the relay UE 103 has been already established. A RRC connection of a Uu link between the relay UE and the BS 102 has been already established.
(2) A relayed RRC connection of a link between the UE 101 and the BS 102 is established. The RRC relayed connection of the link is a logical link and may also be named as “an end-to-end link” between the UE 101 and the BS 102.
(3) The relay UE 103 transmits the RLF notification to the UE 101 when the following condition is met:
   Case 2-1: a RLF between the relay UE 103 and the BS 102 happens;
(4) When the UE 101 receives the RLF notification from the relay UE 103:
   the UE 101 is triggered to monitor a discovery resource pool; and
   the AS layer of the UE 101 delivers the information of RLF to the NAS layer of the UE 101.
(5) The relay UE 103 transmits a successful recovery notification upon completing a recovery procedure.
   After receiving the successful recovery notification, the UE 101 stops a relay reselection procedure; or
   after receiving the successful recovery notification, the UE 101 stops monitoring a discovery resource pool.
(6) The relay UE 103 transmits a recovery failure notification to the UE 101 upon a recovery failure of a recovery procedure.
   When the UE 101 receives the recovery failure notification, the UE 101 is triggered to initiate a relay reselection procedure.

FIG. 10 illustrates a simplified block diagram of an apparatus for a failure handling procedure in accordance with some embodiments of the present application.

In some embodiments of the present application, the apparatus 1000 may be a UE (e.g., UE 101 as illustrated and shown in FIG. 1, UE (a) as illustrated and shown in FIG. 2, or the UE as illustrated and shown in FIG. 3), which can at least perform the method illustrated in FIG. 9.

In some other embodiments of the present application, the apparatus 1000 may be a relay UE (e.g., the relay UE 103 as illustrated and shown in FIG. 1 or UE (b) as illustrated and shown in FIG. 2), which can at least perform the method illustrated in FIG. 5, FIG. 7 or FIG. 8.

In some additional embodiments of the present application, the apparatus 1000 may be a BS (e.g., the BS 102 as illustrated and shown in FIG. 1 or the BS as illustrated and shown in FIG. 3), which can at least perform the method illustrated in FIG. 6.

As shown in FIG. 10, the apparatus 1000 may include at least one receiver 1002, at least one transmitter 1004, at least one non-transitory computer-readable medium 1006, and at least one processor 1008 coupled to the at least one receiver 1002, the at least one transmitter 1004, and the at least one non-transitory computer-readable medium 1006.

Although in FIG. 10, elements such as the at least one receiver 1002, the at least one transmitter 1004, the at least one non-transitory computer-readable medium 1006, and the at least one processor 1008 are described in the singular, the plural is contemplated unless limitation to the singular is explicitly stated. In some embodiments of the present application, the at least one receiver 1002 and the at least one transmitter 1004 are combined into a single device, such as a transceiver. In certain embodiments of the present application, the apparatus 1000 may further include an input device, a memory, and/or other components.

In some embodiments of the present application, the at least one non-transitory computer-readable medium 1006 may have stored thereon computer-executable instructions which are programmed to implement the operations of the methods, for example as described in view of any one of FIGS. 5-9, with the at least one receiver 1002, the at least one transmitter 1004, and the at least one processor 1008.

Those having ordinary skills in the art would understand that the operations of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.”

What is claimed is:

1-8. (canceled)

9-15. (canceled)

16-24. (canceled)

25-30. (canceled)

31-41. (canceled)

42. An apparatus, comprising:
at least one non-transitory computer-readable medium having stored thereon computer-executable instructions;
at least one receiving circuitry;
at least one transmitting circuitry; and
at least one processor coupled to the at least one non-transitory computer-readable medium, the at least one receiving circuitry and the at least one transmitting circuitry,
wherein the computer-executable instructions cause the at least one processor to:
establish a PC5 radio resource control (RRC) connection of a link between a UE and the relay UE;
establish a RRC connection of a link between the relay UE and a base station (BS);
establish a relayed connection of a link between the UE and the BS;
detect whether a failure occurs on the link between the UE and the relay UE; and
in response to detecting that the failure occurs on the link between the UE and the relay UE, transmit failure information to the BS.

43-46. (canceled)

47. The apparatus of claim 42, wherein the computer-executable instructions cause the at least one processor to detect that the failure occurs on the link between the UE and the relay UE, in response to at least one of:
reaching a maximum number of retransmissions of a radio link control (RLC) entity of the relay UE;
an expiry of a timer for transmission of RRC reconfiguration for sidelink;
reaching a maximum number of consecutive hybrid automatic repeat request (HARQ) discontinuous transmission (DTX);
an integrity check failure;
a listen before talk (LBT) failure; and
a beam failure recovery failure.

48. The apparatus of claim 42, wherein the computer-executable instructions cause the at least one processor to:
transmit a RRC reconfiguration sidelink message to the UE;
receive a RRC reconfiguration failure sidelink message from the UE; and
in response to receiving the RRC reconfiguration failure sidelink message, detect that the failure occurs on the link between the UE and the relay UE.

49. The apparatus of claim 42, wherein the failure information is included in one of:
a sidelink UE information message;
a control packet data unit (PDU) in a sidelink adaptation protocol (SLAP) layer of the relay UE; and
a medium access control (MAC) control element (CE).

50. The apparatus of claim 42, wherein the failure information includes at least one of:
a failure cause that is one of a listen before talk (LBT) failure; and a beam failure recovery failure;
an ID of the UE; and
an ID of the relay UE.

51. An apparatus, comprising:
at least one non-transitory computer-readable medium having stored thereon computer-executable instructions;
at least one receiving circuitry;
at least one transmitting circuitry; and
at least one processor coupled to the at least one non-transitory computer-readable medium, the at least one receiving circuitry and the at least one transmitting circuitry,
wherein the computer-executable instructions cause the at least one processor to:
establish a relayed logical connection of a link between a UE and a base station (BS);
detect whether a failure occurs on a link between the relay UE and the BS, wherein a PC5 radio resource control (RRC) connection of a link between the UE and the relay UE has been established, and wherein a RRC connection of a link between the relay UE and the BS has been established; and
in response to detecting that the failure occurs on the link between the relay UE and the BS, transmit a failure notification to the UE.

52. The apparatus of claim 51, wherein the failure occurs on the link between the relay UE and the BS is a radio link failure (RLF).

53. The apparatus of claim 51, wherein the failure notification is a RLF notification generated in response to detecting that a radio link failure (RLF) occurs on the link between the relay UE and the BS.

54. The apparatus of claim 51, wherein the computer-executable instructions cause the at least one processor to:
in response to completing a successful RRC re-establishment procedure, transmit a successful recovery notification.

55. The apparatus of claim 51, wherein the computer-executable instructions cause the at least one processor to:
in response to detecting a RRC re-establishment failure on the link between the relay UE and the BS, transmit a recovery failure notification.

56. The apparatus of any claims 51, wherein at least one of the failure notification, the successful recovery notification, and the recovery failure notification is included in one of:
a RRC signaling;
a control packet data unit (PDU) in a sidelink adaptation protocol (SLAP) layer; and
a medium access control (MAC) control element (CE).

57. An apparatus, comprising:
at least one non-transitory computer-readable medium having stored thereon computer-executable instructions;
at least one receiving circuitry;
at least one transmitting circuitry; and
at least one processor coupled to the at least one non-transitory computer-readable medium, the at least one receiving circuitry and the at least one transmitting circuitry,
wherein the computer-executable instructions cause the at least one processor to:
receive a notification associated with a failure from a relay UE, wherein a PC5 radio resource control (RRC) connection of a link between the UE and the relay UE has been established, wherein a RRC connection of a link between the relay UE and a base station (BS) has been established, wherein a RRC relayed connection of a link between the UE and the BS has been established, and wherein the notification associated with a failure indicates a failure on a link between the relay UE and the BS; and
initiate a relay reselection procedure.

58. The apparatus of claim 57, wherein the relay reselection procedure is initiated in response to the notification associated with a failure indicating that a radio link failure (RLF) of the link between relay UE and BS is detected.

59. The apparatus of claim 57, wherein the computer-executable instructions cause the at least one processor to:
receive a successful recovery notification from the relay UE.

60. The apparatus of claim 59, wherein the computer-executable instructions cause the at least one processor to perform one of:
stop the relay reselection procedure; or
stop monitoring a discovery resource pool.

61. The apparatus of claim 57, wherein the computer-executable instructions cause the at least one processor to:
receive a recovery failure notification from the relay UE.

62. The apparatus of claim 36, wherein the at least one processor initiates the relay reselection procedure in response to receiving the recovery failure notification from the relay UE.

63. The apparatus of claim 57, wherein to initiate the relay reselection procedure, the at least one processor:
monitors a discovery resource pool in response to receiving a recovery failure notification from the relay UE.

64. The apparatus of claim 57, wherein to initiate the relay reselection procedure, the at least one processor:
selects a second relay UE; and
establishes a PC5 RRC connection of a link between the UE and the second relay UE.

65. The apparatus of any claims 57, wherein at least one of the notification associated with a failure, the successful recovery notification, and the recovery failure notification is included in one of:
a RRC signaling;
a control packet data unit (PDU) in a sidelink adaptation protocol (SLAP) layer; and
a medium access control (MAC) control element (CE).
